(19) United States
(12) Patent Application Publication
(10) Pub. No.: US 2009/0153311 A1
(43) Pub. Date: Jun. 18, 2009

(54) Car authentication system using telematics and smart card

(75) Inventor: Ki Chang Lee, Seongnam (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/229,647

(22) Filed: Aug. 26, 2008

(30) Foreign Application Priority Data
Dec. 17, 2007 (KR) 10-2007-0132841

(51) Int. Cl. B60R 25/00

(52) U.S. Cl. 340/426.1

(57) ABSTRACT

A car authentication system using telematics and a smart card includes a part unit, a communication unit, and a database server. The part unit includes parts that are provided with respective unique identification numbers and operate in cooperation with one another through CAN communication. The communication unit is provided in a car, is provided with a smart card to provide user information, and is connected to the part unit. The database server stores user information of registered cars and enables telematics communication with the car so that it can compare the user information from the smart card with the stored user information. Based on the comparison, the respective parts can be activated or deactivated.

### CROSS-REFERENCE TO RELATED APPLICATIONS

This application claims priority to Korean Application No. 10-2007-0132841, filed on Dec. 17, 2007, the disclosure of which is incorporated herein by reference.

### BACKGROUND

1. Technical Field

The present invention relates to a car authentication system using telematics and a smart card that, when a theft occurs, can deactivate the parts of a car and/or selectively deactivate unauthenticated parts, thereby protecting a Controller Area Network (CAN) communication network.

2. Background Art

“Telematics” refers to a car wireless Internet service in which a car and wireless communication are combined together. Telematics is a compound word made of “telecommunication” and “informatics.” It is referred to as “automotive telematics” in that it uses an automotive Personal Computer (PC), which enables emails to be exchanged from a car and enables various types of information to be searched for over the Internet. In general, telematics service is provided through collaboration between a car maker and a mobile communication service provider. Depending on the type of service, various types of services, such as reception of news, investment in stocks, e-commerce, financial transactions, hotel reservation, transmission and reception of facsimiles, games, car accident report and car theft report, are enabled. In particular, telematics service is advantageous in that, when a traffic accident occurs, the location of a car involved in the accident is automatically tracked using a Global Positioning System (GPS) satellite, and related information is transferred to the closest rescue station, thereby facilitating rescue activities.

A car may be controlled using wireless communication between the car and a separate server through the telematics communication. New service and control can be realized in such a way that a smart card is installed in a car and stores information of the car, communication between the smart card and a server is used, and CAN communication for enabling respective parts of the car to operate in conjunction with one another is combined with the former communication.

There is a prior art method using an Integrated Circuit (IC) card as a smart card. This method has disadvantages in that the capacity of the storage of the information thereof is limited and the method does not meet the standards of 3.5th generation mobile communication, which has recently been activated.

Communication methods satisfying the standards of 3.5th generation mobile communication enable the exchange of data via high speed downlink packet access (“HSDPA” ) at a speed remarkably faster than that of W-CDMA or CDMA, which is 3rd generation mobile communication technology. HSDPA, which is the core technology of Release 5, announced by the 3rd Generation Partnership Project (3GPP), a 3rd generation asynchronous mobile communication technology standardization organization, in March 2002, refers to packet-based data service in the W-CDMA standard. Using this technology, communication can be performed at a speed five times as fast as W-CDMA. The downlink speed is a maximum of 14.4 Mbps. There is an advantage in that service can be provided by modifying a W-CDMA system without requiring investment in a base station.

Smart cards are being used as Universal Subscriber Identity Modules (USIMs), which are inserted into 3.5th generation mobile communication terminal devices and provide network authentication and additional functions. Detachable SIMs are generally divided into three types: SIMs used in the existing GSM systems, USIMs defined by the 3GPP and the European Telecommunications Standardization Institute (ETSI) and used in W-CDMA systems, and Removable User Identity Modules (R-UIMs) used in synchronous CDMA systems. An international trend toward activation is WCDMA/HSDPA services.

Accordingly, it can be seen that the use of HSDPA as a communication method and the use of a USIM card as an authentication module are advantageous in the foreign and domestic situations from the viewpoints of the accommodation of the future development of technology and the provision of additional services. Services that can be provided using the above scheme include the prevention of car theft and the control of a car.

Prior art technology providing these services have problems, however. With regard to the control of a car, respective parts of a car constitute a network that operates in conjunction with CAN communication. In the case in which unauthenticated parts, which have not been authenticated by a car manufacturer, are included, problems arise in that authentication is frequently attempted over a CAN communication network, synchronization is delayed, and network errors occur in serious cases. Accordingly, it is necessary to exclude unauthenticated parts from the network.

Meanwhile, in the event of a car theft, a thief can use parts of the car after he or she has started the car, which means that mere detection of the theft is not sufficient as a countermeasure. Accordingly, it is necessary to prevent the parts of a car from being used after the theft.

The above information disclosed in this Background section is only for enhancement of understanding of the background of the invention and therefore it may contain information that does not form the prior art that is already known in this country to a person of ordinary skill in the art.

### SUMMARY OF DISCLOSURE

Accordingly, the present invention has been made keeping in mind the above problems occurring in the prior art, and an object of the present invention is to provide a car authentication system that uses an HSDPA scheme and a detachable USIM card, and additionally uses the CAN communication of a car, thereby dealing with the theft of the car and preventing network errors attributable to the cooperative operation of unauthenticated parts.

In order to accomplish the above object, the present invention provides a car authentication system using telematics and a smart card, including a part unit configured to include parts that are provided with respective unique identification numbers and operate in cooperation with one another through CAN communication; a communication unit provided in a car for telematics communication, provided with a smart card for provision of user information, and connected to the part unit through CAN communication; and a database server configured to contain the user information of registered cars and enable telematics communication with the car so that it compares the user information from the smart card with the stored user information, provides operating signals to the communication unit of the car and then activates the respective parts of the part unit through CAN communication if the authentication succeeds, and provides OFF signals and then deactivates the respective parts by turning off the CAN buses of the part units if the authentication fails.

Preferably, the part unit transfers identification numbers of the respective parts to the database server through the communication unit, and the database server is provided with part information of cars, compares the identification numbers with the stored part information, and transmits operating signals for authenticated parts to the communication unit such that authenticated parts are activated while unauthenticated parts are deactivated by turning off CAN buses thereof.

Preferably, the telematics communication between the database server and the communication unit is performed using HSDPA and the smart card installed in the communication unit is a detachable USIM card.

Preferably, the database server stores updated user information and part information whenever a user or part of the car is changed.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above and other features of the invention are discussed infra.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing a car authentication system using telematics and a smart card according to an embodiment of the present invention; and

FIG. 2 is a flowchart of an embodiment of a method of authentication of use of a car.

### DETAILED DESCRIPTION

A car authentication system and a method thereof using telematics and a smart card according to preferred embodiments of the present invention will be described in detail with reference to the accompanying drawings.

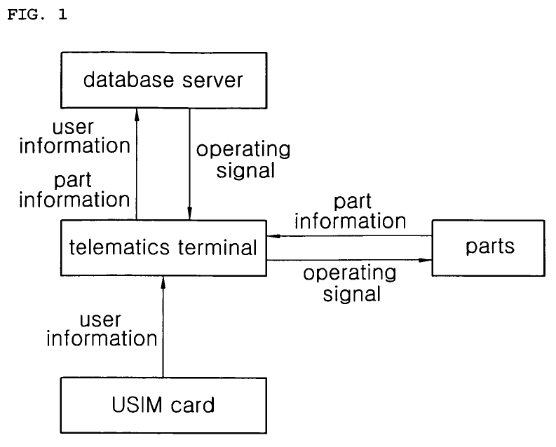

FIG. 1 is a diagram showing a car authentication system according to a preferred embodiment. The system includes a part unit, a communication unit and a database server. The term “parts” of FIG. 1 refers to the part unit in which respective parts operate in conjunction with one another through CAN communication, and the term “telematics terminal” refers to the communication unit for performing wireless communication for the car.

The part unit includes parts of a car that are provided with respective unique identification numbers and operate in conjunction with one another through CAN communication.

The communication unit is connected to the part unit via CAN communication and is provided in the car to perform telematics communication. It is provided with a smart card for providing user information.

The database server stores user information of registered cars. It is configured to perform telematics communication with the car to perform authentication by comparing the user information received from the smart card of the car with the stored user information. The database server provides an operating signal to the communication unit of the car to activate respective parts of the part unit through CAN communication, if the authentication succeeds. On the other hand, it provides OFF signals to deactivate the respective parts by turning off the CAN bus of the part unit, if the authentication fails.

The USIM card of FIG. 1 is an embodiment of the smart card.

Preferably, the part unit transfers the identification numbers of respective parts to the database server through the communication unit. The database server may further store part information of the car and compare the identification numbers with the stored part information for authentication. For authenticated part or parts, it transmits operating signals to the communication unit, thereby activating the part or parts. For unauthenticated part or parts, it turns off CAN bus or buses thereof, thereby deactivating the part or parts.

It is preferred that the telematics communication between the database server and the communication unit be performed using HSDPA, and that the smart card installed in the communication unit be a detachable USIM card.

Furthermore, it is preferred that when user information or part information is updated, the updated user information and part information be stored in the database server, so that authentication can be performed using the updated information.

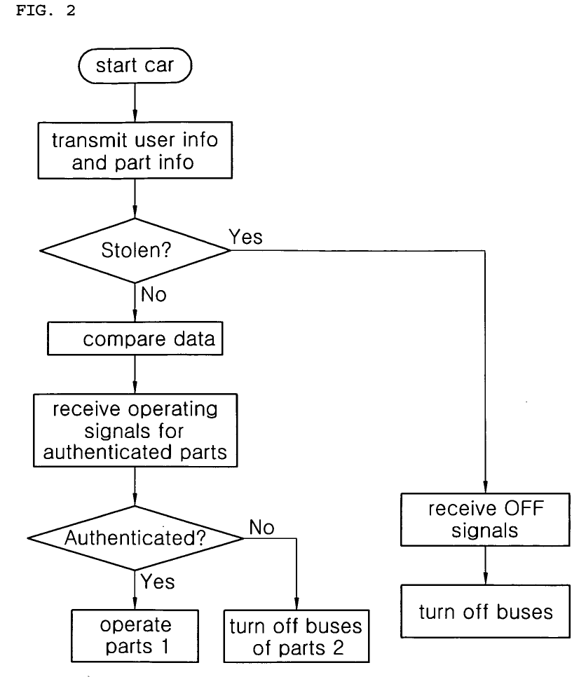

Referring to FIG. 2, an embodiment of a method of authentication of use of a car will be described below.

First, when a car is started, the communication unit of the car connects with the database server and the server requests authentication from the communication unit. The communication unit transmits to the server the user information stored in the USIM card and the unique identification numbers of respective parts configured to operate in conjunction with one another through CAN communication.

Thereafter, the server determines whether a car theft report has been received from the car's owner, and determines whether the car has been stolen by comparing the information of the USIM card with the information of the server. If it is determined that the car has been stolen, that is, if authentication fails, the server transmits OFF signals to the communication unit, and the communication unit then transmits the OFF signals to the CAN network, thereby deactivating all parts of the car by turning off the CAN buses thereof. That is, even if the person who has stolen the car starts the car, he or she cannot use the various parts of the car, and thus it will be impossible to drive the car.

On the other hand, if it is determined that the car has not been stolen, the server compares the part information stored in the server with the identification numbers of respective parts. If they are matched, the server generates operating signals and transmits the signals to the communication unit and the communication unit then transmits them to the CAN network, thereby activating the authenticated part or parts. If they are not matched, CAN bus or buses of the unauthenticated part or parts is/are turned off, causing the unauthenticated part or parts to be deactivated. That is, while the operating signals pass between parts over the CAN network, they selectively activate only the authenticated parts (e.g., parts 1 of FIG. 2), and turn off the CAN buses of unauthenticated parts (e.g., parts 2 of FIG. 2). By doing so, the unauthenticated parts are excluded from the CAN network, so that the unauthenticated parts do not conflict with the authenticated parts and network errors can be prevented in advance. As shown in FIG. 2, for example, an authenticated part 1 start to be activated, and an unauthenticated part 1 is maintained in an idle state because the CAN bus thereof is cut off.

The car authentication system and method using telematics and a smart card as described above can easily meet the next generation mobile communication specifications, efficiently deal with a car theft, and enhance the protection of a car network by preventing unauthenticated parts from joining the CAN network.

Although the present invention has been illustrated and described in conjunction with specific embodiments, it will be apparent to those skilled in the art that the present invention can be variously modified and varied within a range that does not depart form the spirit and scope of the present invention defined by the following claims.

What is claimed is:

1. A car authentication system using telematics and a smart card, comprising:
a part unit including parts that are provided with respective unique identification numbers and operate in cooperation with one another through Controller Area Network (CAN) communication;
a communication unit provided in a car for telematics communication, provided with a smart card for provision of user information, and connected to the part unit through CAN communication; and
a database server storing user information of registered cars and configured to enable telematics communication with the car so that the database server compares the user information received from the smart card with the user information stored in the database server, provides operating signals to the communication unit to activate the respective parts through CAN communication if the user information received from the smart card matches the user information stored in the database server, and provides OFF signals to deactivate the respective parts by turning off CAN buses of the part unit if the user information received from the smart card does not match the user information stored in the database server.

2. The car authentication system as set forth in claim 1, wherein the telematics communication between the database server and the communication unit is performed using High-Speed Downlink Packet Access (HSDPA) and the smart card installed in the communication unit is a detachable Universal Subscriber Identify Module (USIM) card.

3. The car authentication system as set forth in claim 1, wherein when the user information is changed, the database server updates user information.

4. The car authentication system as set forth in claim 1, wherein:
the part unit transfers the identification numbers of the respective parts to the database server through the communication unit; and
the database server further stores part information of the registered cars and is configured to enable telematics communication with the communication unit so that the database server compares the identification numbers with the part information stored in the database server and, if it is determined that they are matched, transmits operating signals to the communication unit to activate the part or parts while, if they are not matched, turns off CAN bus or buses of the part or parts to deactivate the part or the parts.

5. The car authentication system as set forth in claim 4, wherein the telematics communication between the database server and the communication unit is performed using High-Speed Downlink Packet Access (HSDPA) and the smart card installed in the communication unit is a detachable Universal Subscriber Identify Module (USIM) card.

6. The car authentication system as set forth in claim 4, wherein when the part information is changed, the database server updates part information.

7. A method for authenticating use of a car including parts that operate in cooperation with one another through CAN communication, comprising:
storing user information of registered cars in a database server;
storing user information in a smart card to be installed in a communicated unit of the car;
comparing the user information stored in the smart card with the user information stored in the database server; and
providing operating signals to the communication unit to activate the parts through CAN communication if the user information stored in the smart card matches the user information stored in the database server, and providing OFF signals to deactivate the parts by turning off CAN buses thereof if the user information stored in the smart card does not match the user information stored in the database server.

8. The method as set forth in claim 7, wherein the comparison is performed through telematics communication between the database server and the communication unit and the telematics communication is performed using High-Speed Downlink Packet Access (HSDPA) and the smart card is a detachable Universal Subscriber Identify Module (USIM) card.

9. The method as set forth in claim 7, further comprising updating the user information.

10. The method as set forth in claim 7, further comprising:
providing the parts with respective unique identification numbers;
storing part information of the registered cars in the database server;
comparing the identification number of a part or the identification numbers of the parts with the part information; and
activating the part or parts if the identification number or numbers match the part information, and deactivating the part or parts by turning off CAN bus of buses thereof if the identification number or numbers does not match the part information.

11. The method as set forth in claim 10, wherein the comparison is performed through telematics communication between the database server and the communication unit and the telematics communication is performed using High-Speed Downlink Packet Access (HSDPA) and the smart card is a detachable Universal Subscriber Identify Module (USIM) card.

12. The method as set forth in claim 10, further comprising updating the part information.
